(19) United States
(12) Patent Application Publication
(10) Pub. No.: US 2006/0249084 A1
(43) Pub. Date: Nov. 9, 2006

(54) Method and apparatus for collection of fluids

(76) Inventors: Grant Thomas Rawlin, Kilmore East (AU); Brian David Muller, Bentleigh (AU); James Gerrard Thompson, Tatura (AU); Carl Gregory Russell, Tatura (AU); Leon Thomas Schreiber, Toolamba (AU); Kristen Elizabeth Murphy, Kyabram (AU)

Correspondence Address: Gunnar G. Leinberg;Nixon Peabody, Clinton Square, P O Box 31051, Rocheter, NY, 14603-1051, US

(21) Appl. No.: 10/560,489

(22) PCT Filed: Jun. 10, 2004
(86) PCT No.: PCT/AU04/00773

§ 371 Date: Apr. 27, 2006

(30) Foreign Application Priority Data
Jun. 11, 2003 (AU) 2003902953
Jul. 16, 2003 (AU) 2003903684

(51) Int. Cl. A01J 5/04

(52) U.S. Cl. 119/14.43

(57) ABSTRACT

An apparatus for use with a milking machine comprising one or more teat cups and a vacuum source providing a vacuum in the teat cups, for collecting a small volume of liquid for cold storage, the apparatus comprising: a) a fluid collection receptacle (15) having an opening (17) for collecting fluid, b) a housing for the fluid collection receptacle (15) comprising an inlet (12) for receiving the liquid from the one or more teat cups and a port for providing a vacuum within the housing from said vacuum source, and c) means for retaining (14) the opening (17) of the receptacle (15) to receive liquid via the housing inlet (12). A milking system incorporating the apparatus is also claimed.

This invention relates to a method and apparatus for the collection of small volumes of fluid from the teats of mammals, and to a milking system incorporating such an apparatus and its use.

### BACKGROUND

A range of dairy-derived products can be made from selected secretions taken from the mammary glands of mammals, such as cows. The secretions may be selected on the basis of the time of production, pursuant to the administration to the mammals of a particular course of treatment, or of a particular sub-category of animals within a larger animal population.

Examples of such secretions and extracts thereof include:
colostrum extract, which can be made from the mammary secretion of cows at a point in time shortly after parturition. In this case, the composition of the colostrum may change significantly as a function of milk volume within the first milking and also as a function of the number of milkings since parturition (generally less than 6);
hyperimmune colostrum extract, which can be made from colostrum taken from mammals which have been given a particular course of treatment, for example, a course of vaccinations against an antigen over a period of 3 months prior to parturition;
immune colostrum extract, which can be made from colostrum taken from a sub-category of animals that have been identified as carriers of particular antibodies of interest, for example antibodies with neutralising power against anthrax or Shiga toxin;
milk extract, which can be made from cows milk pursuant to the cows being fed a particular diet, for example a diet rich in particular antioxidants or essential oils;
milk from animals that have been selected or genetically modified for their capacity to secrete a valuable substance such as a vaccine antigen; and
hyperimmune milk, which comprises cows milk pursuant to the cows being vaccinated with an antigen.

Frequently the volume of these types of secretions taken from each dairy farm is significantly less than the volume of milk which is taken in the course of a routine milking. This is because few cows in the herd provide the desired secretions. This can give rise to a number of problems associated with collecting these secretions. The collection volume is often insufficient to fill the milk lines of milking machines leading to contamination with out-of-specification material and/or unacceptable wastage.

The collection volume is also generally insufficient to fill standard milk vats, leading to poor refrigeration, the need to install customised vats to handle low volumes, and the need to arrange milk collection on a non-routine schedule. If low volume reservoirs such as test buckets are used, contamination can readily occur between successive animals and the labour associated with adequate cleansing between animals is onerous. In particular it is generally necessary to remove the lid of the test bucket between animals, leading to the deposition of contamination in the harvested secretion. This problem is exacerbated by the practice of locating the test bucket behind and beneath the rear end of the animals so that the buckets commonly become contaminated with faecal material. The problem of contamination is further exacerbated by the need to pour the secretions from the test bucket, which has a contaminated outside, into a separate storage container.

In the event that a modest volume of secretions is frozen prior to distribution to a processing facility, the depth of liquor frozen frequently exceeds 10 centimetres and in consequence, the process of freezing significantly diminishes the local homogeneity of the frozen secretion. This is problematic when samples are taken for quality control, and leads to the need for expensive and inconvenient on-farm liquid sampling. Another problem arises when the freezing time becomes excessive.

Other methods which have previously been used to collect small volumes of secretions from the mammary glands of mammals include hand milking into a small reservoir. This is an impractical collection method as it significantly disrupts the routine of a busy commercial dairy.

Another method is drip sampling into a herd test sampler. In this case a small amount of sample corresponds to a larger volume of milk running through the milking machine. This method does not permit the collection of a small volume of a high value secretion.

Another option is to construct a customised vat with a preset batch volume limit (eg 150 litres—this may be considered the minimum acceptable volume for pick-up by a tanker). The difficulties associated with this method include the high set-up cost and significant wastage.

U.S. Pat. No. 5,913,281 describes a method for separating the foremilk from the milk yield. An auxiliary reservoir is provided between the teat cups and the main milk vat. The foremilk is diverted into the reservoir at the commencement of the milking process. This method is not suitable for harvesting the low volume component which may not substantially reside in the foremilk.

### SUMMARY

The invention provides an apparatus for use with a milking machine comprising one or more teat cups and a vacuum source providing a vacuum in the teat cups, for collecting a small volume of liquid for cold storage, the apparatus comprising:
a fluid collection receptacle having an opening for collecting fluid;
a housing for the fluid collection receptacle comprising an inlet for receiving the liquid from the one or more teat cups and a port for providing a vacuum within the housing from said vacuum source; and
means for retaining the opening of the receptacle to receive liquid via the housing inlet.

In a further embodiment the invention provides a milking system comprising an apparatus for collecting a small volume of liquid such as colostrum, the system comprising:
a plurality of teat cups;
a vacuum source for applying a vacuum to the teat cups for collecting liquid;
a container for collecting relatively large volumes of milk; and
an apparatus as described above for collecting relatively small volumes of liquid.

### DETAILED DESCRIPTION

The apparatus of the invention may be used in conjunction with a milking machine of known type. Such milking machines are common in commercial dairies but are typically designed to collect large volumes of for example, milk.

The apparatus of the invention comprises:
a fluid collection receptacle having an opening for collecting fluid;
a housing for the fluid collection receptacle comprising an inlet for receiving the liquid from the one or more teat cups and a port for providing a vacuum within the housing from said vacuum source; and
means for retaining the opening of the receptacle to receive liquid via the housing inlet.

The fluid collection receptacle is preferably a flexible bag.

The housing inlet for receiving the liquid from one or more teat cups preferably comprises a conduit protruding into the housing and means for retaining the receptacle (particularly a flexible bag) about the opening of the inlet to receive fluid therefrom.

In a particularly preferred embodiment the receptacle is a flexible fluid collection bag comprising a collar defining the opening. The collar may be relatively rigid when compared with the flexible bag and be adapted to receive a closure for sealing the bag for cold storage. Preferably the collar is sufficiently rigid to retain its shape when retained about the inlet conduit by the retaining means. In this embodiment the housing inlet preferably comprises a conduit extending into the housing and said means for retaining the bag cooperates with the collar to retain the collar so that the inlet extends into the flexible bag through the opening. This embodiment is particularly advantageous as it allows efficient safe collection of clean product and yet is relatively inexpensive and convenient to operate. In contrast to the collection receptacle which is preferably flexible the housing is preferably rigid whereby the vacuum is transferred to the inlet.

The flexible bag typically has a volume of at least 500 ml when filled with liquid and preferably is a lay flat bag providing a width of no more than 20 cm when filled with liquid and placed on a flat surface. More preferably the width of the bag is no more than 10 cm when filled with liquid and placed on a flat surface. The bag volume is preferably from 5 to 40 litres, more preferably from 10 to 25 litres and most preferably from 15 to 25 litres.

The housing will generally comprise a top wall a sidewall and bottom wall. The housing preferably comprises a lid portion comprising the top wall and a body portion comprising the sidewall and bottom wall. The lid portion preferably comprises said fluid inlet and said port for providing a vacuum. In this embodiment the lid portion preferably comprises a conduit for receiving liquid extending down from said top wall to provide an inlet port within the housing spaced down from the top wall. Retaining means may be provided, for example on the outside of the conduit, for cooperating with a collar of the flexible bag so that the flexible bag receives liquid from the inlet.

The collar may be provided with a flange (or other means) for engaging the retaining means. The lid portion is preferably provided with an inlet filter in line with the housing inlet for removing solids from the liquid drawn into the housing inlet by a vacuum applied to said port.

The retaining means may be a clip, spring or other suitable retainer which cooperates with the receptacle (preferably a receptacle collar forming the receptacle opening) to retain the receptacle. The clip in a preferred embodiment comprises a portion opposed to the inlet conduit. The opposed portion may be resilient and preferably allows a portion of the receptacle (preferably the collar) to be retained between opposing portion of the retaining means and inlet conduit.

The retaining means may be integrally formed with a lid portion of the housing and may be attached to the outside of the inlet conduit or other portion of the housing.

The filter may be partly integral with the housing lid. The filter or portion thereof may be integral with the inlet conduit particularly the up stream end of the inlet conduit.

In an alternative, though less preferred embodiment one or both of the vacuum port and fluid inlet are formed in the sidewall of the housing.

In a further embodiment the invention provides a milking system comprising an apparatus for collecting a small volume of liquid such as colostrum, the system comprising:
a plurality of teat cups;
a vacuum source for applying a vacuum to the teat cups for collecting liquid;
a reservoir for collecting relatively large volumes of milk; and
an apparatus as described above for collecting relatively small volumes of liquid.

The milking system will typically also include a pressure oscillation means for providing pulsating vacuum to the teat cups and a vacuum line downstream of the apparatus for collecting relatively small volumes of liquid.

The milking system may comprise a multiplicity of milking stations including at least one station for delivering small volumes of liquid to the apparatus of the invention as hereinbefore described.

In yet another embodiment the invention provides a method of collecting a small volume of liquid such as colostrum from the mammary glands of mammals such as cows comprising:
collecting secretions in a flexible bag;
sealing the opening in the bag; and
freezing the colostrum in the bag to provide a thickness of frozen colostrum of less than 20 cm (preferably less than 15 cm).

The secretions (particularly colostrum) are preferably collected shortly after parturition. Our copending patent applications PCT/AU03/00348 and PCT/AU03/00616 describe products such as colostrum and hyperimmune colostrum which may be collected using the apparatus of the invention.

In accordance with a further aspect the invention provides a flexible bag for collection of a fluid and providing a sample of the bag contents, the bag comprising a bag body for receiving a liquid via an opening and a sampling pocket (preferable integrally formed with the interior of the bag) separated from the interior of a main body of the bag by an elongated seal. The pocket comprises an entrance for receiving liquid from the interior of the main body of the bag. The sampling pocket may be divided from the main body of the bag by an elongated seal. The elongated seal generally extends from an edge and may have a free end defining an opening with an adjacent edge of the bag. The elongated seal together with the portions of the bag wall (and optionally also one or more further elongated seals) define the entrance to the pocket which provides a passage between the interior main body and the pocket for allowing a sample of the bag contents to be forced into the pocket when the bag opening is sealed.

In one embodiment the bag comprises two or more opposed sheet portions sealed together. The sheet portions may be separate sheets joined by a peripheral seal or portions of a folded sheet or tube sealed at either end. In one embodiment the pocket is formed by an interrupted elongate seal extending between two parts on the periphery of the bag the interruption providing an entrance to the pocket. It is particularly convenient where the bag has four edges so that the interrupted seal may extend across intersecting edges to form a pocket at one corner. In an alternative and simpler embodiment the pocket is formed by a heat seal extending from an edge of the bag. A passage between the main body of bag and pocket may be provided between the end of the pocket wall and an adjacent edge of the bag. If the bag has four edges the heat seal may extend from a first edge and extend to form a wall (separating the pocket from the main body of the bag) spaced from an edge of the bag intersecting the first edge.

Typically the pocket will have a volume of no more than 5% of the total volume of the flexible bag.

In the case of a lay flat bag the area of the pocket in the lay flat condition is typically no more than 5% of the bag. Typically the area of the bag when flat (ie one side) is from 10,000 mm² to 1 m².

The bag of the invention is preferably generally rectangular when flat with the pocket being formed adjacent one end. The opening of the bag is preferably closer to the end in which the pocket is formed so that when the bag is retained about the inlet of the fluid collection receptacle the pocket is in the upper part of the bag and fluid is collected in the lower part of the bag.

The sample may be taken from liquid collected in the bag by a relatively simple procedure. The bag will generally be sealed and the contents of the bag agitated to thoroughly mix the liquid and ensure the sample is representative of the contents. To fill the pocket liquid may then be introduced to the pocket by forcing it through the opening of the pocket to the interior of the main body of the bag. The contents of the bag and pocket may subsequently be frozen and the sample in the pocket removed by breaching an outer wall of the pocket. When the bag is formed with a rectangular seal the sample may be removed by breaching a portion of the seal which forms a wall of the pocket. A clip may be applied to the outside of the bag to seal the opening of the pocket from the interior of the bag body before freezing. A suitable clip is of the type for clipping flexible sheets together comprising a resilient outer member having a retaining portion of C-shaped cross-section and a cylindrical inner member received within the outer member with the flexible sheets there between. The outer member preferably has longitudinal edge portions joining C-shaped ends the longitudinal edge portions may curve laterally to provide an omega shaped cross-section.

When an outer wall of the pocket is breached to remove a sample from the product it may be desirable to apply one or more additional clips to reseal the breached wall. This will serve to guard against leakage of liquid from the main body of the bag. The opening of the pocket to the interior of the main body of the bag may be provided by an interruption of the seal which is of dimensions of from 1 mm to 50 mm and preferably 2 mm to 20 mm. Preferably, however, the opening of the pocket is provided by a seal extending from an edge of the bag and having a free end spaced from an edge of the bag to provide for passage therebetween for liquid to enter the pocket.

The flexible bag used in the method is preferably a lay flat bag having a collar and a fill volume of at least 500 ml. The lay flat bag preferably provides a maximum thickness of the flat section of less than 20 cm and more preferably less than 10 cm.

An embodiment of the invention will now be described with reference to the attached drawings.

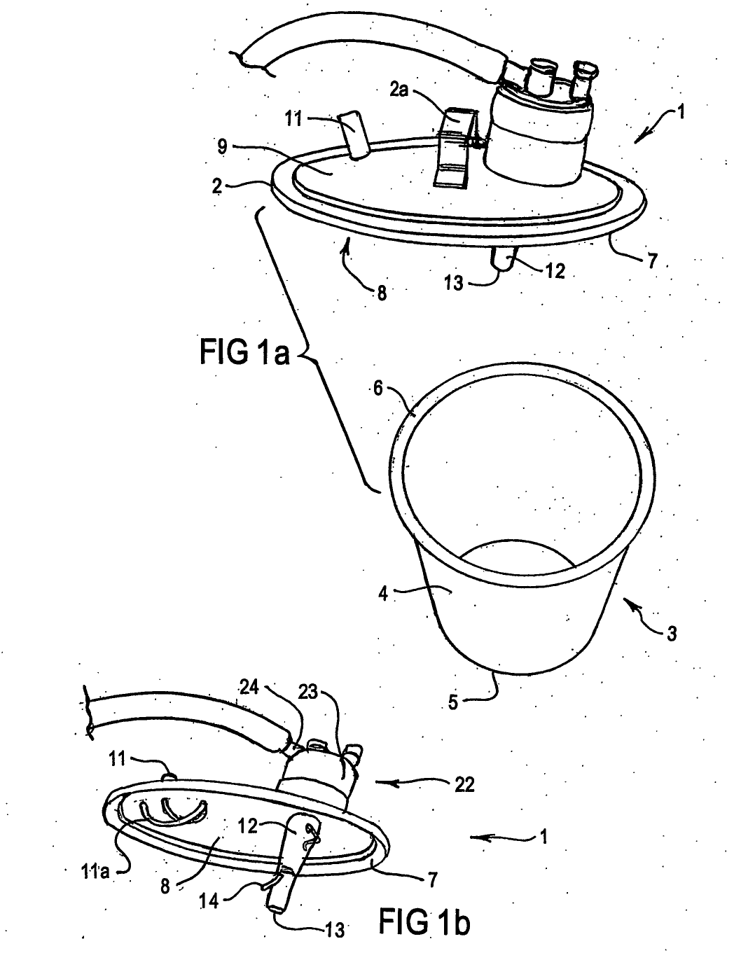

FIG. 1a shows an apparatus in accordance with the invention without the fluid receptacle;

FIG. 1b shows the lid of an apparatus of FIG. 1a with detail of the underside;

FIG. 1c shows a fluid collection bag attached to the inlet conduit of the apparatus of FIG. 1a;

FIG. 1d shows a schematic cross section of an alternative inlet conduit arrangement;

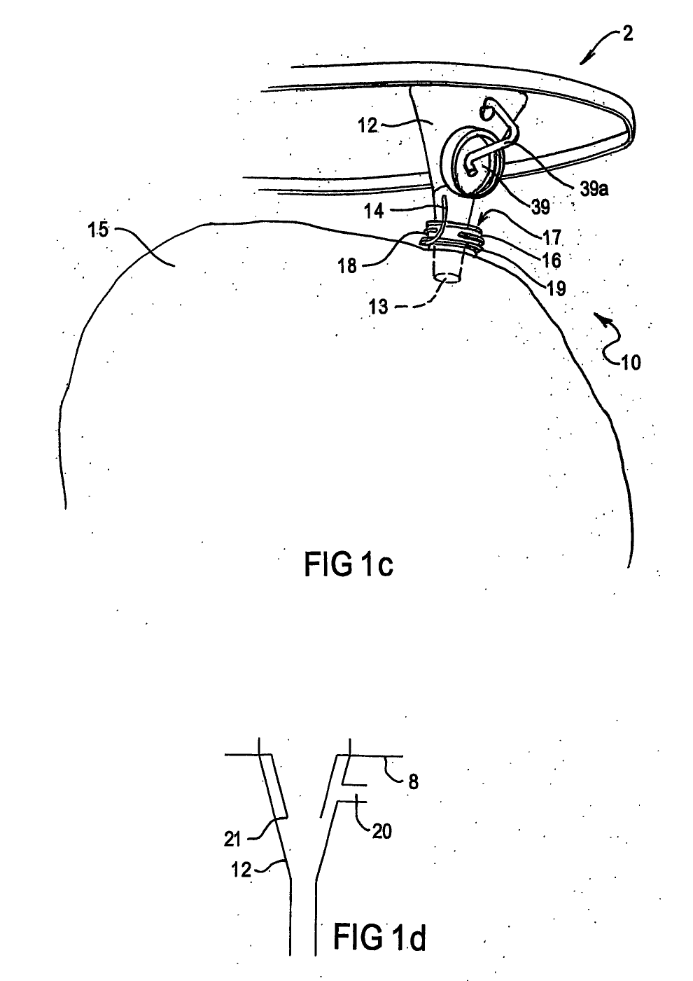

FIG. 2 is a schematic diagram showing a conventional milking system with collection for three cow stations shown; and

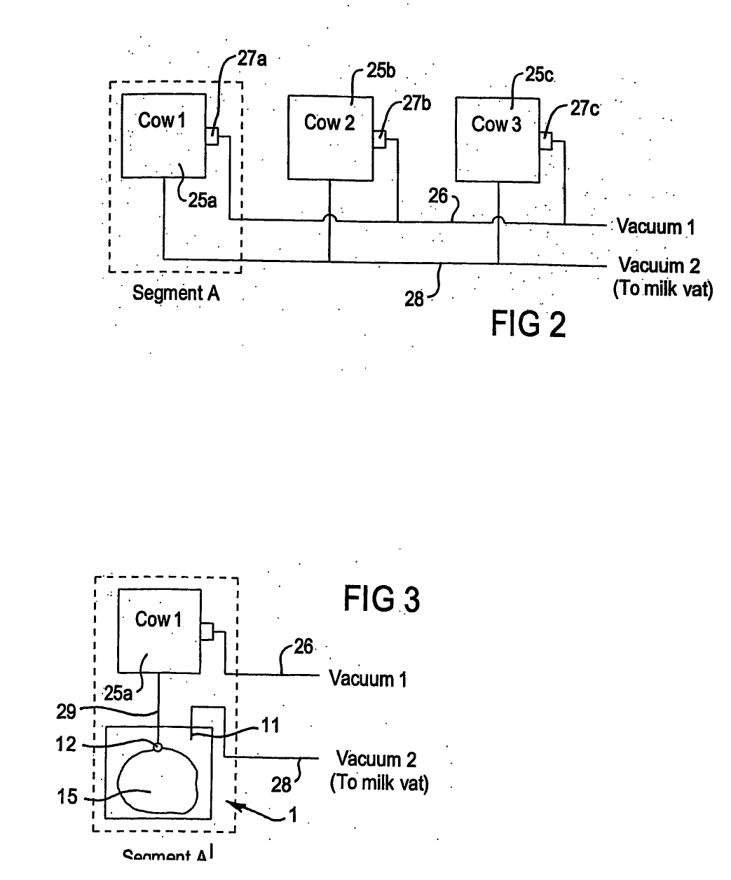

FIG. 3 is a schematic drawing of a station from a milking system of FIG. 2 which has been modified with the apparatus of the invention for collection of small volume of mammary secretion such as colostrum at cow station 1.

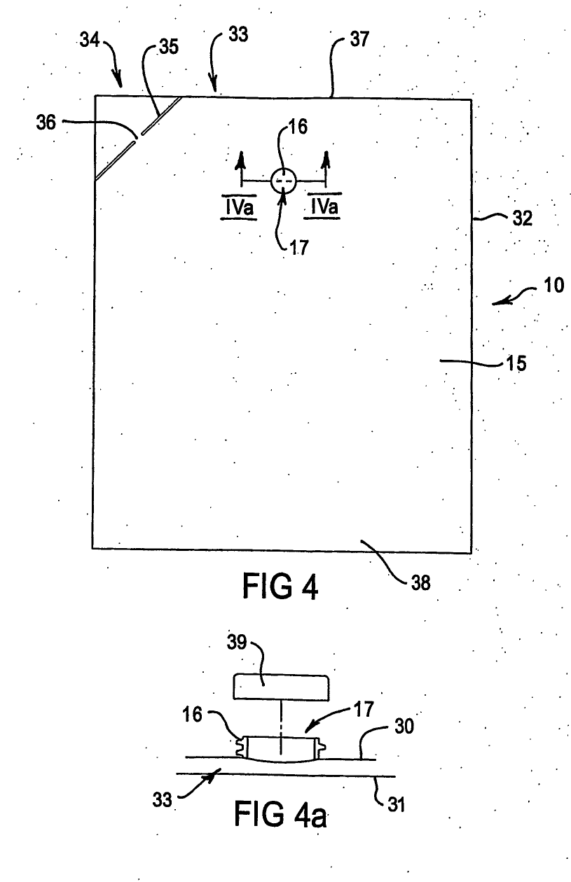

FIG. 4 shows a first example of a fluid collection bag comprising a sampling pocket in accordance with one aspect of the invention.

FIG. 4a is a part cross-section of the bag of FIG. 4 along the dotted line IVa-IVa′.

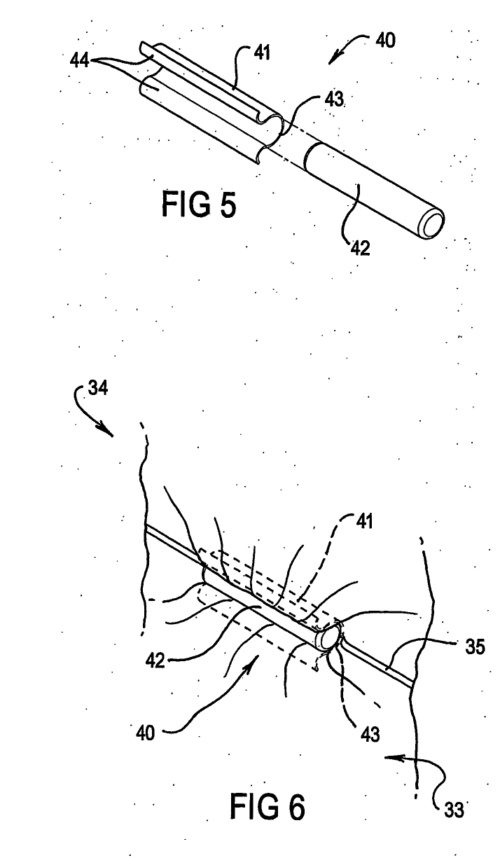

FIG. 5 is a clip which may be used to close the opening in the sample pocket.

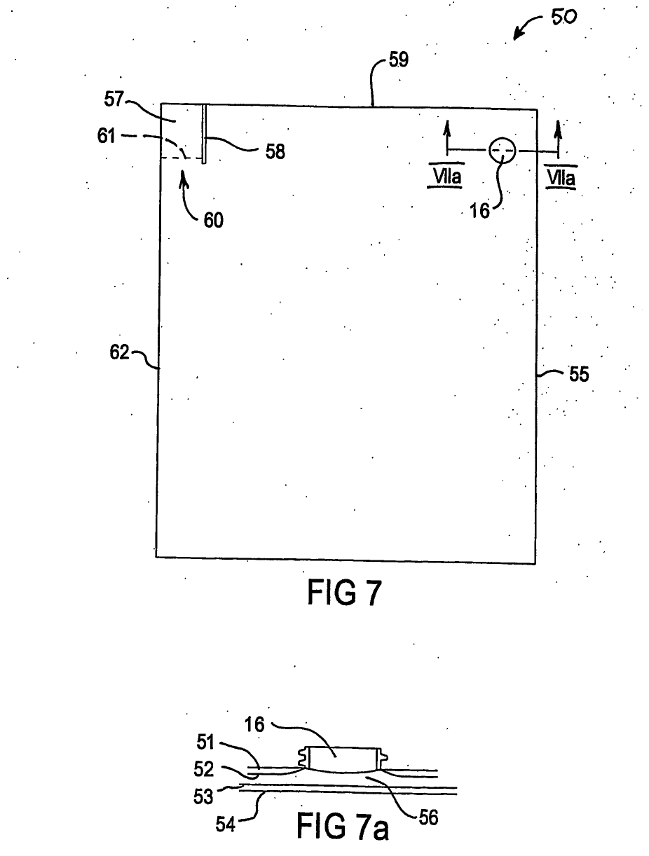

FIG. 6 is an expanded view of the clip of FIG. 5 located over the opening in the sample collection pocket of the bag of FIG. 4.

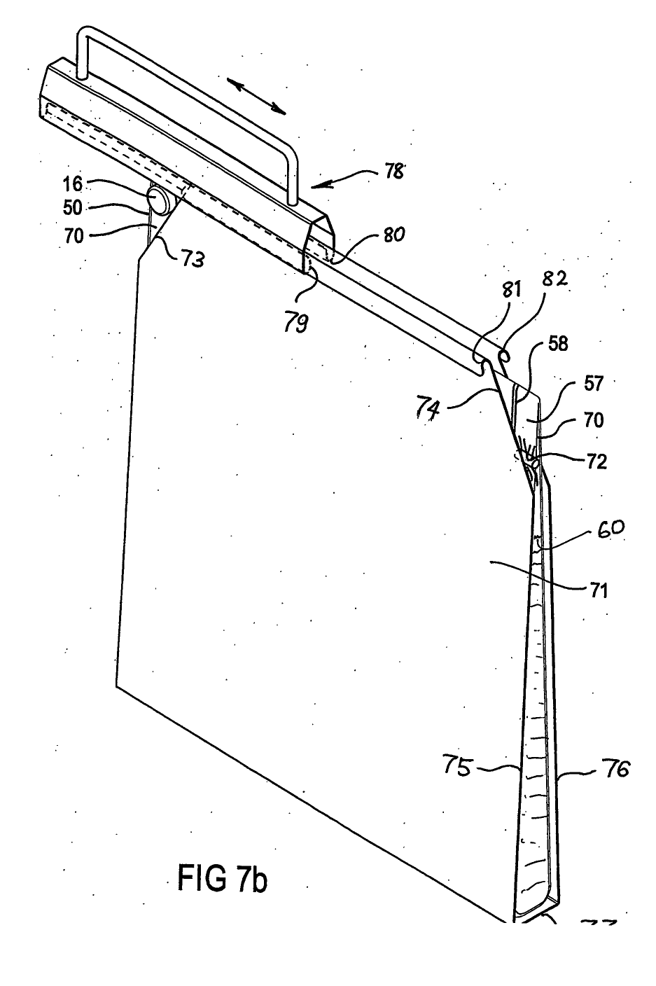

FIG. 7 shows a second example of a fluid collection bag comprising a sample pocket.

FIG. 7a is a part cross-section of the bag of FIG. 7 along the line indicated. VIIa-VIIa′ which shows the collar and the double wall construction.

FIG. 7b is a front view of a fluid collection bag for use in the invention located in a compartment for freezing.

Referring to the drawings, FIGS. 1a, 1b and 1c show an apparatus of the invention comprising a housing (1) and flexible bag (10). The housing (1) comprises lid portion (2) optionally provided with a handle (2a) and body portion (3).

The body portion comprises a sidewall (4) a bottom wall (5) and an upper end (6) of the sidewall (4) for cooperating with and forming a seal with the periphery (7) of the underside of the lid (2). The underside (8) of the lid (2) inboard of the periphery (7) forms a top wall of the housing (1). The outer side (9) of lid (2) is provided with a vacuum port (11) for connection to a vacuum line for placing the housing (1) under vacuum when the underside periphery (7) of lid (2) is seated on the upper end (6) of said wall (4) of the body (3).

The lid is further provided with a liquid inlet conduit (12) ending in an inlet port (13) within the housing (1) which is spaced below the underside (8) of the lid (2). The inlet conduit (12) is provided with a retaining means (14) for retaining a flexible bag (10). Flexible bag (10) comprises a bag body (15) formed of a flexible plastic material such as a polyolefin, polyester, suitable laminate or the like (such as are known in the art for storage of liquid food products) and a semi-rigid collar (16) providing an opening (17) for the bag. The collar (16) has an outside (18) provided with a flange (19) which cooperates with the retaining means (14) to locate the collar about the inlet conduit (12) with the inlet port (13) located within the flexible bag (10). There is space between the collar (16) and conduit (12) to allow vacuum to be applied to the opening (13) of the inlet conduit (12) from the vacuum port (11). The flexible bag body (15) is preferably a lay flat bag which when filled with liquid and placed on a flat surface is less than 15 cm thick preferably less than 10 cm thick. It preferably has a capacity of at least 500 ml and more preferably from 500 ml to 50 litres and most preferably from 15 to 25 litres.

The vacuum applied to the vacuum port (11) is transferred to the inlet conduit (12) via the opening (17) in the bag (10) (as shown in FIG. 1c) or by other suitable means such as the arrangement shown in FIG. 1d where a pressure equalising port (20) is provided in the conduit (12) and an internal conduit (21) is provided for transferring liquid below the port (20) to prevent liquid being sucked out of the pressure equalising port (20). When a pressure equalising port is present the collar (16) may be sealed about the inlet conduit (12).

Upstream of the inlet conduit (ie toward the source of secretions or milk) is a filter (22) which is connected with the top (or outside) (9) of the lid (2) and may be at least partly integral with the lid (2).

The underside (8) of the lid (2) may be provided with means for preventing the flexible bag (10) from blocking the vacuum port (11) such as a cage (11a) as shown in FIG. 1b. The collar (16) of the receptacle (10) may be (and preferably is) adapted to receive a cap (39). In order to provide good hygiene it is preferred that the housing interior is provided with a clip (39a) for retaining the cap (39) during fluid collection.

The filter generally has a filter housing (23) with an inlet (24) for receiving liquid upstream of the inlet conduit (12) and filter elements (not shown) such as filter disks or filter sock of a type known in the art.

Referring to FIG. 2 a milking machine of a type known in the art is shown which comprises a number of cow stations (25a, 25b, 25c) each comprising a multiplicity of teat cups (generally four) provided with a pulsing vacuum line (26) provided with pressure oscillation means (27a, 27b, 27c) at respective stations (25a, 25b, 25c) to provide interrupted vacuum from the vacuum source to withdraw milk from the teats. Milk withdrawn is transferred to a milk vat by liquid transfer line (28) which is under vacuum at the downstream end.

FIG. 3 shows a system of the invention according to FIG. 2 which is provided with an apparatus described above with reference to FIGS. 1a, 1b and 1c for collecting relatively small volumes of milk from each cow milked at the first station (25a). The volume is relatively small compared with the milk collected by the milking system. In order to incorporate the apparatus of the invention the vacuum line (28) for transferring milk to the vat is disconnected from the teat cup cluster (27a) and connected to vacuum port (11) of the housing. The removed vacuum line is replaced on the teat cup cluster (27a) by connection to the inlet conduit (12) of the apparatus (1). Alternatively similar rerouting of the vacuum could be achieved by a permanent parallel line and valves for bringing the apparatus into line during collection of small volumes of fluid.

The inlet (12) of the apparatus of the invention (1) is joined by line (29) to the teat cups at the first station (25a). The vacuum port (11) of apparatus (1) is connected to a vacuum line (28) to provide a reduced pressure within the housing and draw fluid from the first cow station (25a) into the bag (15).

In order to facilitate the taking of a representative sample of liquid once the contents of the bag have been frozen a clip may be applied across a section of the bag containing collected liquid such as a corner portion to form a sample appendix prior to freezing and for removal after freezing. The clip may be in the form of a tube member having an elongated slot for receiving a section extending across the bag to define the appendix and an elongated member for retaining the section of bag within the tube so as to close off the bag and isolate said appendix portion.

A particularly preferred flexible bag construction constitutes the further aspect of the present invention. The bag which will now be described with reference to FIGS. 4 to 7, while particularly useful in conjunction with the collection vessel of the present invention, may be used in other collection apparatus or for storage and sampling. FIG. 4 shows an empty bag (10) in accordance with this aspect of the invention. The bag (10) is formed of two sheets of thermoplastic material (see FIG. 4a). The thermoplastic sheets (30, 31) are joined by a heat seal at the periphery (32) of the bag (10) and the interior is divided into a main body interior (33) which is provided with an opening (17) to the outside of the bag for collection of liquid. The interior of the bag also comprises a sample collection pocket (34) separated from the main body of the bag (33) by a longitudinal seal (35) which is interrupted to define the opening (36) of the pocket (34) to the main body of the bag interior (33). The pocket opening (36) provides a passage for transferring a liquid from the interior of the main body of the bag (33) to the sampling pocket (34).

The pocket is located adjacent one end of the bag (37) and the opening (17) of the bag (10) is generally closer to the same end (37) than the remote end (38). Liquid is collected through the opening (17) by suspending the bag (10) from the mouth (16) defining the opening (17) (see FIG. 1c) and accordingly the end adjacent the pocket (37) is the upper end of the bag during liquid collection. Liquid therefore collects in the remote end (38) and fills toward the opening (17). When the required volume of liquid has been collected the bag is removed from the inlet (13) of the collection apparatus (1) and a cap (39) is applied to provide a liquid tight seal.

During collection of a complex liquid such as milk, components of the liquid such as fat or the like may separate from the liquid. To collect a representative sample, the liquid is agitated to form a homogeneous mixture and the bag oriented so that the liquid is adjacent the seal (35) defining the opening (36) of the pocket (34) to the main body of the bag interior (33). Pressure is applied to the liquid to force a sample through the pocket opening (36) and provide a suitable volume of sample within the pocket (34).

In order to facilitate the maintenance of good seal within the bag and isolation of the sample, a sampling clip (40) is preferably used as shown in FIG. 5. The sampling clip (40) has two components including a first and outer member (41) comprising a C-shaped cross-section (43) and longitudinal edges (44) curved literally to provide an omega cross-section. The first member (41) is resilient enabling it to admit the second component (42) which is generally cylindrical. The components form a clip by locating the flexible materials to be clipped about the inner member (42) and locating the inner member within the outer member (41) with the clipped flexible material therebetween.

FIG. 6 shows exploded view of the seal separating the pocket and main body of the bag depicted in FIG. 4. In the exploded view shown in FIG. 6 the interruption of the seal (36) (shown in FIG. 4) has been closed by a sampling clip (40) of the type shown in FIG. 5. The second (generally cylindrical) inner component of the clip (42) is placed across the opening of the pouch (36) and outer member (41) is forced over the inner member from the other side of the bag to trap the bag therebetween and seal the opening (36).

FIGS. 7 and 7a shows a fluid collection bag which may be used as an alternative to that shown in FIG. 4. In FIG. 7 the bag (50) comprises four layers of plastic (51, 52, 53, 54, see FIG. 7a) heat sealed (55) at their periphery (see FIG. 7) to provide a double walled bag.

The interior of the bag (56) comprises a sample collection pocket (57) defined by an elongated heat seal 58 between the bag layers (51, 52, 53, 54) which extends from the peripheral seal (55) at the top edge (59) to provide a packet opening at the remote end (60) of the product heat seal (58). A sample may be taken from the bag contents by mixing and transferring liquid into the pocket which may then be trapped in the packet using a sampling clip of type shown in FIG. 5 in a line (61) extending from the pocket heat seal (58) adjacent the remote end (60) to the adjacent bag edge (62).

The liquid such as milk may be frozen for storage in the bag. A representative sample located in the pocket (34) may be removed without disturbing the frozen liquid in the main body of the bag (33) by breaching the peripheral seal or wall of the bag at one edge within the pocket and removing the frozen sample. In the illustrated example the pocket sample will typically be of triangular (see FIG. 4) or rectangular shape (see FIG. 7).

The bag of the invention allows liquid to be conveniently sampled with a minimum disruption and without compromising the bulk of the collected liquid. FIG. 7b shows a fluid collection bag (50) with collected fluid (61) located therein which is confined in a compartment (71) to confine the bag so as to provide a thickness of less than 20 cm (preferably less than 10 cm) on freezing. A sample of the fluid collected (70) is confined in the pocket (57) and isolated from the contents of the bag by an omega clip (72) (of type shown in FIG. 5).

The compartment (71) includes cut out portions (73, 74) to provide access to the collar (16) and sample pocket (57) and allow easy removal of the sample after freezing. The compartment (71) is preferably in the form of a case adapted to be opened to allow removal of the bag (50) or may be in the form of a vertical or horizontal compartment within a freezer.

The depicted case comprises front and back plates (75, 76) joined by a base plate (77) which spaces the front and back plates to receive the bag therebetween. The case may comprise a removable handle (78) comprising a pair of spaced apart channel portions (79, 80) for slidally engaging complementary channel portions (81, 82) at the upper end of the front and back plates (75, 76) whereby the case may be lifted by the handle (78) with a fluid filled bag therein.

Finally, it is understood that various other modifications and/or alterations may be made without departing from the spirit of the present invention as outlined herein.

1. An apparatus for use with a milking machine comprising one or more teat cups and a vacuum source providing a pulsed vacuum in the teat cups, for collecting a small volume of liquid for cold storage, the apparatus comprising:
a flexible bag comprising a collar defining an opening;
a housing for the flexible bag comprising an inlet conduit extending into the housing for receiving the liquid from the one or more teat cups and comprising an opening within the housing for delivering the liquid;
a port for providing a vacuum within the housing from said vacuum source; and
a retaining system that retains the collar of the flexible bag about the inlet conduit so that the bag receives liquid from the inlet opening; and
a transfer system that transfers the vacuum from the port for providing a vacuum within the housing to the inlet conduit when the collar of the flexible bag is retainable about the inlet conduit by the retaining system.

2. An apparatus according to claim 1 wherein the transfer system is selected from (a) providing space between the collar and inlet conduit when the collar is retained about the inlet conduit by the retaining system and (b) providing a pressure equalizing port in the inlet conduit.

3. An apparatus according to claim 2 wherein the transfer system comprises a space between the collar and inlet conduit when the collar is retained about the inlet conduit by said retaining system.

4. An apparatus according to claim 1 wherein the collar is relatively rigid when compared with the flexible bag.

5. An apparatus according to claim 1 wherein the dimensions of the collar are greater than the adjacent portion of the inlet conduit to provide a space there between to allow the vacuum applied to the housing to be transferred from the vacuum port to said inlet conduit.

6. An apparatus according to claim 2 wherein the collar of flexible bag is retained with the inlet conduit extending into the flexible bag through the opening.

7. An apparatus according to claim 6 wherein the collar is sufficiently rigid to maintain its shape when retained about the inlet conduit by the retaining system.

8. An apparatus according to claim 7 wherein the flexible bag is a lay flat bag comprising two sides joined by a heat seal.

9. An apparatus according to claim 1 wherein the housing is sufficiently rigid to retain its shape under the vacuum from said milking machine.

10. An apparatus according to claim 1 wherein the receptacle has a volume in the range of from 500 ml to 50 liters.

11. An apparatus according to claim 1 wherein the receptacle has a volume in the range of from 5 litres to 40 litres.

12. An apparatus according to claim 1 wherein the receptacle has a volume in the range of from 10 to 25 litres.

13. An apparatus according to claim 1 wherein the housing comprises a lid comprising the top wall and a body comprising side and bottom walls.

14. An apparatus according to claim 12 wherein the lid comprises said fluid inlet comprising a conduit for receiving liquid extending down from said wall to provide an inlet port within the housing and wherein said lid further comprises the port for providing a vacuum.

15. An apparatus according to claim 1 wherein the inlet conduit is provided with retaining system for cooperating with the collar of the flexible bag.

16. An apparatus according to claim 15 wherein the flexible bag has a relatively rigid collar defining the bag opening and the collar comprises a flange adapted to cooperate with the retaining system to retain the collar for receiving liquid from the inlet.

17. An apparatus according to claim 1 wherein the bag comprises an internal pocket to allow sampling of the bag contents.

18. An apparatus according to claim 17 wherein the internal pocket is formed by a heat seal extending from an edge of the bag.

19. An apparatus according to claim 17 wherein the pocket has a volume of no more than 5% of the total volume of the flexible bag.

20. An apparatus according to claim 1 for collecting a small volume of liquid said apparatus further comprising:
a plurality of teat cups;
a vacuum source for applying a vacuum to the teat cups for collecting liquid;
a reservoir for collecting relatively large volumes of milk; and
a vacuum line for providing a vacuum to the vacuum part of the housing.

21. An apparatus according to claim 20 further comprising a pressure oscillation system that provides pulsating vacuum to the teat cups and a vacuum line downstream of the apparatus for collecting relatively small volumes of liquid.

22. An apparatus according to claim 20 further comprising a case for receiving liquid filled bags for freezing to provide a thickness of less than 20 cm.

23. An apparatus according to claim 1 when used in collection of liquid selected from the group consisting of ungulate colostrum, hyperimmune colostrum and specialty milks.

24. A method for making an apparatus for use with a milking machine comprising one or more teat cups and a vacuum source providing a pulsed vacuum in the teat cups, for collecting a small volume of liquid for cold storage, the method comprising:
providing a flexible bag comprising a collar defining an opening;
providing a housing for the flexible bag comprising an inlet conduit extending into the housing for receiving the liquid from the one or more teat cups and comprising an opening within the housing for delivering the liquid;
providing a port that provides a vacuum within the housing from the vacuum source; and
retaining the collar of the flexible bag about the inlet conduit so that the bag receives liquid from the inlet opening; and
transferring the vacuum from the port to provide a vacuum within the housing to the inlet conduit when the collar of the flexible bag is retained about the inlet conduit.
